(19) United States
(12) Patent Application Publication
(10) Pub. No.: US 2006/0070187 A1
(43) Pub. Date: Apr. 6, 2006

(54) Hand punch tool for notching paper records

(76) Inventor: David N. Chilson, Rochester, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 10/957,765

(22) Filed: Oct. 4, 2004

(51) Int. Cl. B26B 11/00

(52) U.S. Cl. 7/160

(57) ABSTRACT

A tool for cutting a marking in a tag comprising a body; an anvil attached to the body, wherein the anvil comprises a recessed die cavity; a cutter attached to the body, wherein the cutter comprises a punch engageable with the recessed die cavity of the anvil, and a stop for limiting the insertion of the tag between the anvil and the cutter. Additional embodiments of the invention comprise a lens to magnify at least a portion of the tag inserted between the cutter and the anvil, and a pen mechanism for marking the tag.

This invention relates in one embodiment to a hand operated punching tool for punching notches or holes through a sheet of paper, and more particularly to a punching tool for notching and thereby validating a carcass tag for big game (e.g. bear, deer), and/or small game (e.g. turkey) immediately after making a harvest in the field.

### FIELD OF THE INVENTION

Tools for punching or notching a sheet record, thereby indicating the selection and/or marking of specific data on the sheet record.

### BACKGROUND OF THE INVENTION

All of the states of the United States, and all of the Canadian Provinces require that in the practice of game hunting, after the harvesting of an animal in the field, a carcass tag is to be immediately attached to the carcass. To comply with this regulation, hunters must make cuts, notches, and/or holes in the carcass tag in order to indicate the selection of certain specific information on the carcass tag. Such information may include the selection of date (month/day/year), animal gender (M/F), size (weight, height, points, etc.), location of harvest, and the like.

To the best of the applicant's knowledge, no simple, effective, and portable tool for the proper marking of a carcass tag in the field is available for a hunter's use. To the best of the applicant's knowledge, there has not heretofore been available a cutting, notching, or punching device specifically designed for this purpose. Instead, the relatively crude methods employed in the prior art make it difficult and dangerous for the hunter, often resulting in personal injury to himself, by attempting to accomplish this with an tool unsuited for the task such as e.g., a regular utility hunting knife. Additionally, hunters have been fined for improper marking(s) or non-compliance with hunting regulations, because of the difficulty in accomplishing this task, since there is no tool specifically designed for the accomplishment thereof.

Carcass tags are typically prepared on small pieces of paper, laminated adhesive-backed plastic film, and other sheet substrates commonly used to convey printed information. Because the tags are made to be carried in a small pouch or envelope, such as is used to carry hunting tags, licenses, and other card-sized printed sheets of less than about 4 inches high by 6 inches wide, the density of information printed thereupon is typically quite high. Thus, for any particular information set such as e.g., date (month/day/year), the selections available (e.g., 12 months, 31 days, several years) are numerous.

Thus, the size of any individual selection is typically quite small. It will be apparent that the precise and accurate cutting, notching, and/or punching of such selections will be difficult with an unsuited tool such as a hunting knife. In many instances, the selections are so small that they are not only difficult to cut, they are difficult to read. There is therefore a need for a tool that can provide magnification of the indicia to be cut, notched, or punched, in addition to the ability to perform such cutting, notching or punching.

Accordingly, the various embodiments of the present invention are directed to meeting at least one of the following objects of the invention:

It is an object of this invention to provide a tool for cutting selection markings in a tag, wherein the tool is portable.

It is an object of this invention to provide a tool for cutting selection markings in a tag, wherein the tool is simple to use.

It is an object of this invention to provide a tool for cutting selection markings in a tag, wherein the tool is safe to use without risk of injury to the user's fingers.

It is an object of this invention to provide a tool for cutting selection markings in a tag, wherein the tool provides visual magnification of the indicia to be considered for selection and cutting in the tag.

It is an object of this invention to provide a tool for cutting selection markings in a tag, wherein the tool accurately and precisely cuts the desired markings in the tag.

It is an object of this invention to provide a tool for cutting selection markings in a tag, wherein the tool, properly used, enables 100% compliance to tag marking laws of the particular jurisdiction where the game harvest is made.

Other objects of the invention will be made clear or become apparent from the following description and claims when read in light of the accompanying drawings.

### SUMMARY OF THE INVENTION

In accordance with the present invention, there is provided a tool for cutting a marking in a tag, said tool comprising a body; an anvil attached to said body, said anvil comprising a recessed die cavity; a cutter attached to said body, said cutter comprising a punch engageable with said recessed die cavity of said anvil, and means for magnifying a portion of said tag.

In accordance with the present invention, there is further provided a tool for cutting a marking in a tag, said tool comprising a body; an anvil attached to said body, said anvil comprising a recessed die cavity; a cutter attached to said body, said cutter comprising a punch engageable with said recessed die cavity of said anvil, and a stop for limiting the insertion of said tag between said anvil and said cutter.

In accordance with the present invention, there is further provided a tool for cutting a marking in a tag, said tool comprising a body; an anvil attached to said body, said anvil comprising a recessed die cavity; a cutter attached to said body, said cutter comprising a punch engageable with said recessed die cavity of said anvil, and a marking pen contained within said body.

### BRIEF DESCRIPTION OF THE DRAWINGS

The invention will be described by reference to the following drawings, in which like numerals refer to like elements, and in which:

FIG. 1A is a front view of one embodiment of a carcass tag to be cut and marked with embodiments of tool of the present invention;

FIG. 1B is a rear view of the carcass tag of FIG. 1A;

FIG. 1C is a front view of another embodiment of a carcass tag to be cut and marked with embodiments of tool of the present invention;

FIG. 2A is a side view of one embodiment of the tool of the present invention;

FIG. 2B is a top view of the embodiment of FIG. 2A, taken along line 2B-2B of FIG. 2A;

FIG. 3 is a top view of the tool of FIGS. 2A and 2B engaged with a carcass tag in order to perform cutting of such tag;

FIG. 4A is a top view of another embodiment of the tool of the present invention comprising means for magnifying a portion of the tag to be cut.

FIG. 4B is a top view of the tool of FIG. 4A engaged with a carcass tag in order to magnify and perform cutting of such tag;

FIG. 5 is a side view of another embodiment of the tool of the present invention comprising a clip for securing the tool to a sheet of material; and

FIG. 6 is a top view of another embodiment of the tool of the present invention further comprising a key chain assembly.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements. In describing the present invention, a variety of terms are used in the description.

As used herein, the term cutting is used to indicate the act of separating and removing a small portion of a tag from a larger portion of a tag. The small portion removed from the larger portion may include but is not limited to a portion removed at the edge, in the shape of e.g., a triangular notch, a rectangular notch, a semi-circular notch, a rectangular notch with a point at the inboard end thereof, or a rectangular notch with a semicircle at the inboard end thereof; or the small portion may be a shape removed from entirely within the larger portion, such as a circle, or a rectangle. Cutting is typically accomplished by the shearing or crushing action occurring during the engagement of the edges of at least two parts of a tool.

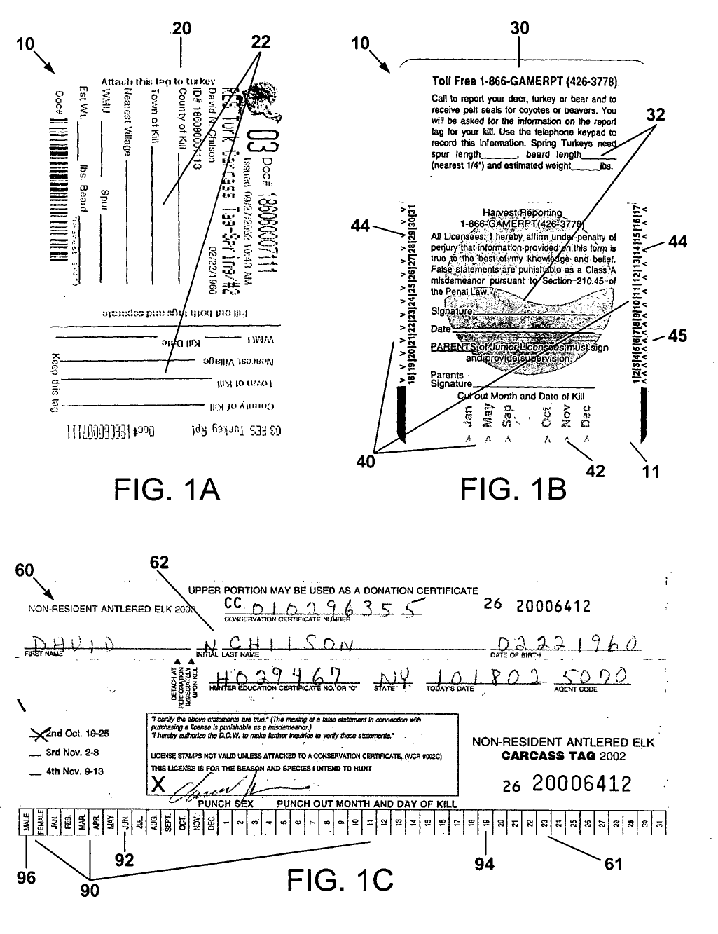

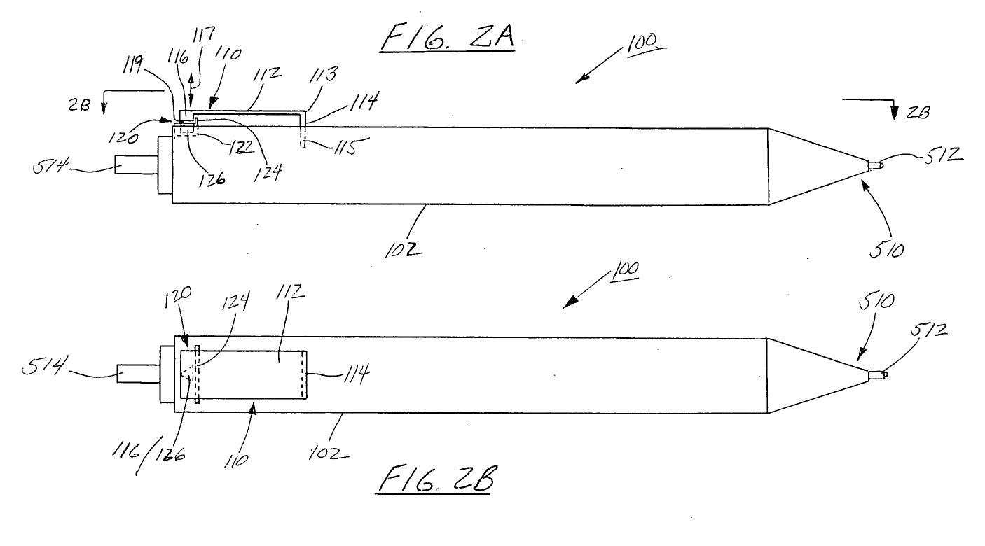

FIG. 1A is a front view of one embodiment of a carcass tag to be cut and marked with embodiments of tool of the present invention, and FIG. 1B is a rear view of the carcass tag of FIG. 1A. Referring to FIGS. 1A and 1B, the front side 20 of one typical carcass tag 10 comprises printed information including blanks 22 to be filled in by the hunter with a writing instrument at the time that a harvest is made. The rear side 30 of tag 10 comprises printed information including further blanks 32 to be filled in by the hunter with a writing instrument at the time that a harvest is made. Rear side 30 of tag 10 further comprises indicia 40 printed at the perimeter 11 thereof. The notching of specific selections 42 and 44 of indicia 40 enables the month and day of the harvest to be permanently recorded on tag 10.

In one embodiment of tag 10 of FIGS. 1A and 1B, tag 10 measures about 2.1 by about 3.4 inches. The single digit indicia 45 (numbers 1-9) are only about 0.07 inches apart, numeral center to numeral center. Hence a proper notch selecting one of these indicia should be no more that about 0.07 inches wide. It will be apparent that this is a difficult task to accomplish properly with a tool such as a utility hunting knife.

FIG. 1C is a front view of another embodiment of a carcass tag to be cut and marked with embodiments of tool of the present invention. Referring to FIG. 1C, carcass tag 60 comprises printed information including blanks 62 to be filled in by the hunter with a writing instrument at the time that the tag is received. Tag 60 further comprises indicia 90 printed at the perimeter 61 thereof. The notching of specific selections 92, 94 and 96 of indicia 90 enables the month and day of the harvest, and the gender of the harvest to be permanently recorded on tag 60. In one embodiment of tag 60 of FIG. 1C, tag 10 measures about 3.2 by about 7.9 inches. The indicia 90 printed thereupon about 0.17 inches apart.

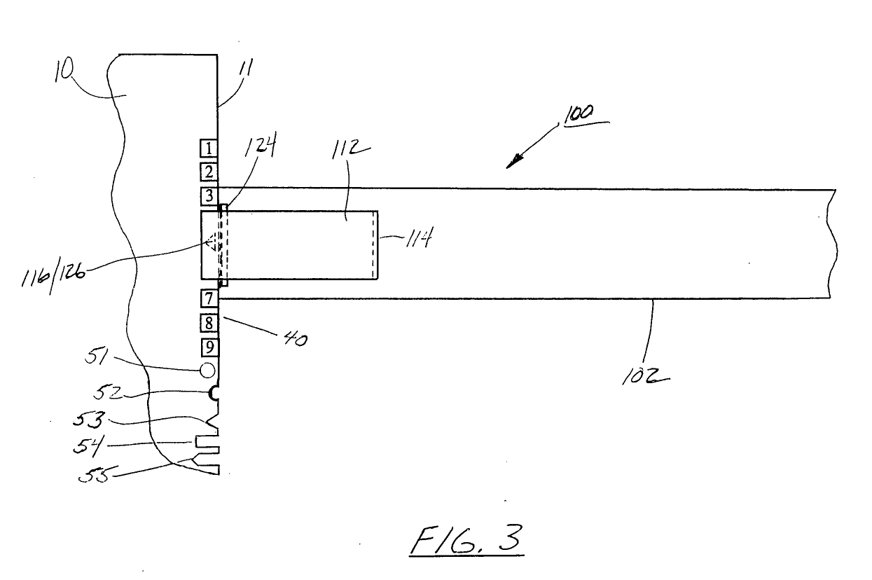

FIG. 2A is a side view of one embodiment of the tool of the present invention; and FIG. 2B is a top view of the embodiment of FIG. 2A, taken along line 2B-2B of FIG. 2A. Referring to FIGS. 2A and 2B, tool 100 comprises a body 102, a cutter 110, and an anvil 120. Body 102 is preferably an elongated rod-shaped structure, which lends itself to ergonomically sound gripping in the palm of the hunter's hand. Body 102 may be rectangular or square in cross-section, or circular. In one embodiment, body 102 is formed with features to engage the fingers of the hand.

For low cost manufacturing, body 102 is preferably circular in cross-section, and more preferably tubular. Body 102 may be made of any suitable inexpensive material, such as plastic, aluminum, or wood. Body 102 is preferably between about ¼ inch in diameter, and about 1 inch in diameter, and more preferably between about ½ inch and about ¾ inch in diameter.

Referring again to FIGS. 2A and 2B, cutter 110 of tool 100 comprises a flexible bar 112, joined at a proximal end thereof to a punch 116, and joined at a distal end thereof to a radial arm 114 by an elbow 113. Anvil 120 comprises a base 122, a stop 124, and a die cavity 126.

Cutter 110 is joined to body 102 of tool 100 by suitable means. In one embodiment, a portion 115 of radial arm 114 is embedded or potted into body 102. Portion 115 may have retaining feature(s) such as e.g., teeth to maintain radial arm 114 of cutter 110 joined to body 102. In another embodiment, cutter 110 is joined to body 102 by adhesive. In another embodiment (not shown), cutter 110 is formed with a ring joined to radial arm 114, wherein such ring encircles and is snugly fitted to body 102.

Flexible bar 114 flexes toward body 102 when force is applied upon punch 116 toward body 102, and flexible bar 114 flexes away from body 102 when such force is released from punch 116. Flexible bar 114 acts as a leaf spring, allowing punch 116 to be displaced into die cavity 126 of anvil 120, and forcing the withdrawal of punch 116 from die cavity 126 when such force is released. In operation, such force is typically provided by the hunter's thumb while he grips body 102 of tool 100 with his fingers.

Flexible bar is preferably made with a material used in the forming of a leaf spring from a piece of thin flat stock, such as e.g., spring steel. Such spring steels, other suitable steels, and other suitable spring materials are well known to those skilled in the art.

Referring again to FIGS. 2A and 2B, anvil 120 comprises a base 122, a stop 124, and a die cavity 126. In one embodiment, base 122 of anvil 120 is embedded or potted into body 102. Base 122 may have retaining feature(s) such as e.g., teeth to maintain base 122 of anvil 120 joined to body 102. In another embodiment, base 122 of anvil 120 is joined to body 102 by adhesive. In another embodiment (not shown), anvil 120 is formed with a ring or sleeve joined to base 122, wherein such sleeve encircles and is snugly fitted to body 102.

Die cavity 126 of anvil 120 is formed to have a shape corresponding to the shape of punch 116 of cutter 110, so that when punch 116 is depressed toward anvil 120, punch 116 enters die cavity 126, such that the perimeters of die cavity 126 and punch 116 are substantially contiguous. Thus the motion of the perimeters of die cavity 126 and punch 116 relative to each other creates a shearing force upon any thin sheet material that is inserted in gap 119 between punch 116 and die cavity 126.

FIG. 3 is a top view of the tool of FIGS. 2A and 2B engaged with a carcass tag in order to perform cutting of a tag such as tag 10 of FIGS. 1A and 1B. Referring to FIGS. 1B, 2A, 2B, and 3, in operating tool 100 to cut a carcass tag, such carcass tag 10 is inserted into gap 119 of tool 100 with punch 116 aligned with the desired indicia value 40, until perimeter 11 of tag 10 is butted up against stop 124 of anvil 120. Force toward body 102 is then applied to punch 116 of cutter 110, cutting a small portion or piece of carcass tag 10 from the large portion of carcass tag 10, as punch 116 shears through carcass tag 10 and penetrates into die cavity 126. Force is then released from punch 116, which springs outwardly. Carcass tag 10 can then be withdrawn from tool 100.

Tool 100 may be provided in a variety of embodiments wherein punch 116 of cutter 110 and die cavity 126 of anvil 120 are formed with a variety of perimeters, and stop 124 of anvil 120 is located in a variety of positions, thus resulting in a variety of cut shapes from tag 10, all of which may be suitable and in compliance with hunting regulations. Referring again to FIG. 3, in one embodiment, tool 100 is provided with a die cavity 126, a punch 116, and a stop 124 positioned such that a circle 51 is punched from tag 10. In another embodiment, tool 100 is provided with a die cavity 126, a punch 116, and a stop 124 positioned such that a semi-circle 52 is punched from tag 10. In another embodiment, tool 100 is provided with a die cavity 126, a punch 116, and a stop 124 positioned such that a triangular notch 53 is punched from tag 10. In another embodiment, tool 100 is provided with a die cavity 126, a punch 116, and a stop 124 positioned such that a rectangle 54 is punched from tag 10. In another embodiment, tool 100 is provided with a die cavity 126, a punch 116, and a stop 124 positioned such that a polygon 55 is punched from tag 10. It will be apparent that a variety of suitable shapes may be cut from tag 10 by tool 100 that clearly indicate the selection of a particular indicium.

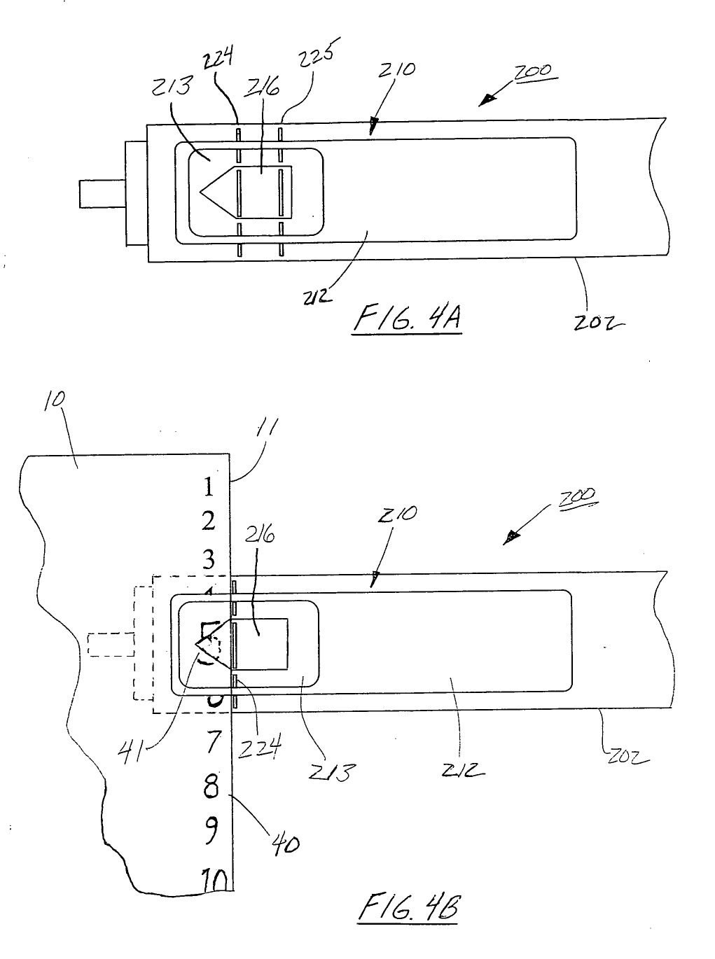

As was previously described, the accurate selection of an indicium to be punched from tag 10 may be difficult, as the indicia are often quite small. Such a difficulty is obviated by another embodiment of the present invention. FIG. 4A is a top view of such embodiment comprising means for magnifying a portion of the tag to be cut. FIG. 4B is a top view of the tool of FIG. 4A engaged with a carcass tag in order to magnify and perform cutting of such tag. Referring to FIGS. 4A and 4B, tool 200 comprises body 202, cutter 210, and stop 224 of the anvil (not shown, see anvil 120 of FIGS. 2A and 2B). Cutter 210 further comprises magnifying means 213, which magnifies the particular indicium of tag 10 that is inserted in the gap between cutter 210 and the anvil (not shown).

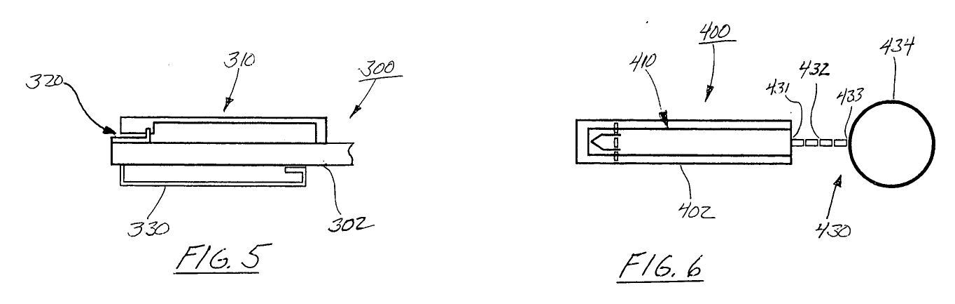

For example, the numeral 41 is shown in FIG. 5 being magnified by magnifying means 213. In operating tool 200 to cut a carcass tag, such carcass tag 10 is inserted into the gap between cutter 210 and the anvil (not shown) until perimeter 11 of tag 10 is butted up against stop 224 of the anvil. The position of tag 10 in the gap is adjusted until the desired indicium is visible in the gap. The desired indicium 41 is more easily seen due to the magnification provided by magnifying means 213 as shown in FIG. 4B. When the desired indicium is properly aligned with punch 216, the cutting operation is performed as described previously.

Magnifying means may be provided in any suitable configuration that provides magnification of the desired indicia 41. In one embodiment depicted in FIGS. 4A and 4B, magnifying means 213 is a magnifying lens. Such magnifying lens 213 may be set in a cavity in flexible bar 212, much as a jewel is fitted and held in a setting. In such an embodiment, punch 216 is joined to the underside of lens 213 by suitable means such as e.g., adhesive. Lens 213 may be made of a suitable plastic used in optical applications, of glass, or quartz, or of any other material suited to make inexpensive lenses.

In one embodiment, lens 213 is optically clear, i.e. lens 213 provides only magnification, with no other effect on the appearance of the indicium viewed therethrough. In a preferred embodiment, lens 213 has a filtering effect that renders the object viewed therethrough as being colored, or having a colored tint. Such colored tint appears to enhance the contrast of a viewed indicium (such as a letter or number) versus the background upon which it is printed, as perceived by a human eye. In particular, it is preferred that such lens have a filtering effect that renders the object being viewed therethrough as having a yellow colored tint. For the purpose of this specification, such a lens providing a colored tint is considered a “colored lens;” and a lens providing a yellow tint is considered a “yellow lens.” In these colored lenses, e.g., a yellow lens, the exact combination of wavelengths of light filtered out may vary, while still achieving a “yellowing” effect by such yellow lens.

In another embodiment, magnifying means 213 is provided as a unitary structure. In other words, the entire cutter 210 including the flexible bar 212 and the punch 216 is made of a clear, hard, flexible plastic such as e.g., polymethylmethacrylate, or polycarbonate. Thus the cutter 210 is provided with a magnifying section that is geometrically similar to the structure of the lens previously described, thereby providing substantially the same magnifying effect on indicia 41.

In yet another embodiment, cutter 210 is provided such that element 213 simply a substantially clear window, enabling the alignment of indicia 41 with punch 216 to be seen by the user, but without magnification.

In the embodiment of tool 200 depicted in FIGS. 4A and 4B, punch 216 is provided with a shape that can cut a notch in a tag having the shape of notch 55 of FIG. 3. Alternatively, if tag 10 is inserted into the cutting gap 119 (see FIG. 2A) at a lesser depth, notch 53 may be cut. Depending upon the particular tag, either notch may be preferred. Accordingly, in one embodiment, tool 200 is provided with a first stop 224 that stops the tag 10 at a shallow depth and produces a shallow notch e.g., notch 53 of FIG. 3 (see also FIG. 4B); and with a second stop 225 that stops the tag 10 at a deeper depth and produces a deeper notch e.g., notch 55 of FIG. 3.

Further embodiments of the present invention are provided which have additional functions. Referring to FIGS. 2A and 2B, for example, tool 100 may be further enhanced with the provision of marking or writing means 510. In one embodiment, writing means 510 may comprise a pen tip 512. Such pen tip may be covered by a cap (not shown) or such pen tip may be extended and retracted by a plunger mechanism 514 having a spring (not shown). Such writing mechanisms such as e.g., ballpoint pens are well known. Such an embodiment having marking capability and cutting capability is considered particularly advantageous, as the marking and cutting of a game tag may be performed by a single small tool.

Other embodiments of the present invention may include lighting means, such as e.g., a penlight having a battery, conductors, and a light bulb; attachment to a tool assembly comprising many additional tools such as e.g. a “Swiss Army Knife”, a “Leatherman,” or a “Gerber;” clip means to clip the tool to a hat brim or other object; a compass; or other knife blades.

The cutting tool of present invention may also be provided with features that enhance the portability and ready availability thereof. FIG. 5 is a side view of another embodiment of the tool of the present invention having such a feature, comprising a clip for securing the tool to a sheet of material. Referring to FIG. 5, tool 300 comprises body 302, cutter 310, and anvil 320, all having the functions and structure as embodiments described previously. Tool 300 further comprises clip 330 securing the tool to a sheet of material. Clip 330 will typically be used to secure tool 300 to a shirt pocket, a pants pocket, a hunting vest pocket, or a hunting tag pouch.

In a further embodiment, the orientation of cutter 310 and anvil 320 is reversed on body 302, i.e. with respect to the longitudinal axis of body 302. In such an embodiment, cutter 310 provides the additional function of being able to be used as a clip to hold the tool to a sheet of material.

FIG. 6 is a top view of another embodiment of the tool of the present invention further comprising a key chain assembly. Referring to FIG. 6, tool 400 comprises body 402, cutter 410, and anvil 420, all having the functions and structure as embodiments described previously. Tool 400 further comprises key chain assembly 430 comprised of chain 432 joined at a proximal end 431 thereof to body 402, and at a distal end 433 thereof to key ring 434.

Other embodiments of the invention include graphic information on the bodies of the tools, such as advertising messages, slogans, logos, addresses, phone numbers, conservation and hunting related information, and the like. In other embodiments, the preferred shapes of the bodies of such tools may be other than cylindrical, in order to provide optimal appearance of such graphics.

It is, therefore, apparent that there has been provided, in accordance with the present invention, a tool for punching or notching a sheet record, thereby indicating the selection and/or marking of specific data on the sheet record. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A tool for cutting a marking in a tag, said tool comprising
a. a body;
b. an anvil attached to said body, said anvil comprising a recessed die cavity; and
c. a cutter attached to said body, said cutter comprising a punch engageable with said recessed die cavity of said anvil.

2. The tool as recited in claim 1, wherein said body is tubular.

3. The tool as recited in claim 1, wherein said cutter further comprises a flex bar joined at a proximal end thereof to said punch and at a distal end thereof to a radial arm by an elbow.

4. The tool as recited in claim 3, wherein said flex bar consists essentially of steel.

5. The tool as recited in claim 1, wherein said anvil further comprises a base and at least one stop.

6. The tool as recited in claim 1, wherein a perimeter of said die cavity and of said punch are triangular.

7. The tool as recited in claim 1, wherein said cutter further comprises means for magnifying a portion of said tag.

8. The tool as recited in claim 7, wherein said means for magnifying a portion of said tag is a lens.

9. The tool as recited in claim 8, wherein said lens consists essentially of plastic.

10. The tool as recited in claim 9, wherein said lens is a colored lens.

11. The tool as recited in claim 10, wherein said colored lens is a yellow lens.

12. The tool as recited in claim 7, wherein said magnifying means is unitary with said cutter.

13. The tool as recited in claim 1, wherein said tool further comprises a marking pen contained within said body.

14. The tool as recited in claim 1, wherein said tool further comprises a clip.

15. The tool as recited in claim 1, wherein said tool further comprises lighting means.

16. The tool as recited in claim 1, wherein said tool further comprises a keychain assembly.

17. The tool as recited in claim 1, wherein said tool further comprises a stop for limiting the insertion of said tag between said anvil and said cutter.
